(19) United States
(12) Patent Application Publication
(10) Pub. No.: US 2026/0349452 A1
(43) Pub. Date: Nov. 5, 2026

(54) AUTONOMOUS MULTI-TRANSPORT DRONE FLEET MANAGEMENT

(71) Applicant: Hughes Network Systems, LLC, Germantown, MD (US)

(72) Inventors: Mustafa Rangwala, New Market, MD (US); Ian Dias, Oak Hill, VA (US); Tim Young, Clarksburg, MD (US); Josh Watters, Elkridge, MD (US)

(21) Appl. No.: 19/195,208

(22) Filed: Apr. 30, 2025

(51) Int. Cl. G05D 1/698; G05D 101/00; G05D 101/15; G05D 109/20; G05D 111/30; H04W 4/44; H04W 36/00; H04W 36/24

(52) U.S. Cl. CPC G05D 1/6987; H04W 4/44; H04W 36/0009; H04W 36/24; G05D 2101/15; G05D 2101/22; G05D 2109/20; G05D 2111/32

(57) ABSTRACT

A multi-transport drone fleet management architecture is described for seamless, domain-agnostic control over a diverse fleet of drones. Each drone can communicate via multiple transport networks, such as cellular and satellite networks. The fleet management architecture incorporates a fleet controller, a dynamic configuration and management system (DCMS), and a data analytics system (DAS) that operate together to facilitate real-time off-board data processing, dynamic mission management, and autonomous re-tasking of drones based on data analytics and/or operational needs. Embodiments can support multi-transport communication, vendor-agnostic drone control, and/or sophisticated collaborative missions using swarms of drones, enhancing operational efficiency and mission capabilities across various applications.

### BACKGROUND

Unmanned vehicles, commonly known as drones, have significantly advanced in recent years, finding applications in various fields such as surveillance, inspection, delivery services, and security operations. There exist both high-cost, low-volume (HCLV) autonomous vehicles and low-cost, high-volume (LCHV) autonomous vehicles. HCLV drones are sophisticated and tend to be used for specialized missions like providing air support for military fighter jets. In contrast, LCHV drones are typically deployed in large numbers for tasks such as facility maintenance, security patrols, and widespread surveillance operations.

Traditionally, both categories of drones operate using line-of-sight (LoS) communications and rely heavily on on-board data processing to execute mission tasks. The limitations of single transport networks, such as terrestrial radio links or basic satellite connections, have constrained the operational range and capabilities of these drones. Communication with ground control systems is often hampered by the range and reliability of these networks, especially when drones operate beyond visual line-of-sight (BVLOS).

### BRIEF SUMMARY

Systems and methods are disclosed for automated management of a fleet of unmanned vehicles (drones). Embodiments operate across multiple domains and/or utilizing various transport networks for communication. Some embodiments are drone provider-agnostic, enabling integration and management of different types of unmanned vehicles. Embodiments include a fleet management architecture having some or all of an off-board transport interface, a fleet controller, a dynamic configuration and management system (DCMS), autonomous engines (AEs), a data analytics system (DAS), and supporting data repositories. In some cases, each drone is equipped with an on-board system that includes an on-board transport interface capable of communicating over multiple transport networks (e.g., cellular networks, satellite networks), an autonomous engine interface, an on-board control system, and various sensors for data collection.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a multi-transport drone fleet management architecture 100, according to embodiments described herein.

FIG. 2 shows a block diagram of an illustrative fleet management system, according to embodiments described herein.

FIG. 3 shows a partial architecture including a block diagram of an illustrative on-board system, according to embodiments described herein.

FIG. 4 illustrates a network architecture depicting illustrative transport networks and communication pathways within a multi-transport drone fleet management system, according to embodiments described herein.

FIG. 5 shows a flow diagram of a method for fleet deployment and data processing in an autonomous multi-domain drone fleet management architecture, according to embodiments described herein.

FIG. 6 shows a flow diagram of a method for transport network transitioning in an autonomous multi-domain drone fleet management architecture, according to embodiments described herein.

FIG. 7 shows a flow diagram of a method for executing a predetermined mission departure in an autonomous multi-domain drone fleet management architecture, according to embodiments described herein.

FIG. 8 shows a flow diagram of a method for drone tasking, re-tasking, and/or reconfiguration in an autonomous multi-domain drone fleet management architecture, according to embodiments described herein.

FIG. 9 provides a schematic illustration of an embodiment of a computational system that can implement various system components and/or perform various steps of methods provided by various embodiments.

### DETAILED DESCRIPTION

The following detailed description is intended to provide several examples that will illustrate the broader concepts that are set forth herein, but it is not intended to limit the invention or the application and uses of the invention. Furthermore, there is no intention to be bound by any theory presented in the preceding background or the following detailed description.

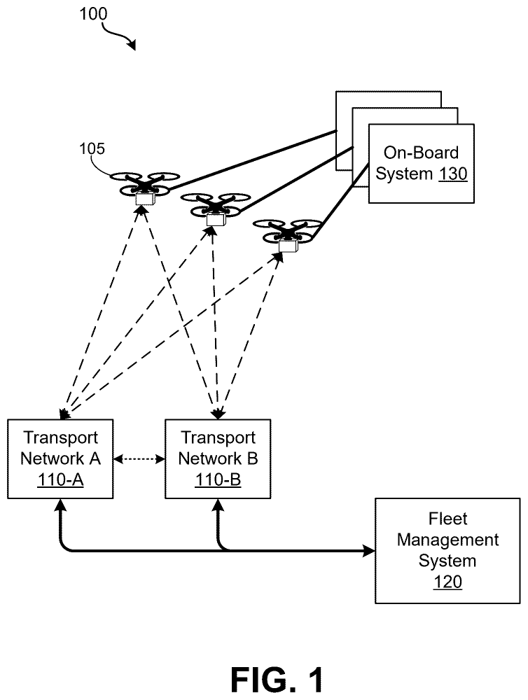

FIG. 1 shows a block diagram of a multi-transport drone fleet management architecture 100, according to embodiments described herein. This architecture 100 provides an integrated system for managing a fleet of drones 105 that can operate across various domains and communicate over multiple transport networks 110. Embodiments of the architecture 100 are drone provider-agnostic, supporting various types of drones and enabling them to perform complex missions with enhanced capabilities by providing resilient communications and inference-based mission management.

The drones 105 represent a fleet of unmanned vehicles. In some implementations, the drones 105 represent a diverse fleet of unmanned vehicles capable of operating across various environments and performing an extensive range of tasks. These unmanned vehicles can include, but are not limited to, unmanned aerial vehicles (UAVs), unmanned ground vehicles (UGVs), unmanned surface vehicles (USVs), unmanned underwater vehicles (UUVs), space drones, lunar drones, and/or extra-planetary or other drones. Each type of drone can be designed with specific characteristics and functionalities tailored to its operational domain and mission requirements, enabling the architecture 100 to support multifaceted mission profiles. As one example, drones in space (e.g., on the moon, on mars, in space, etc.), can be commanded and/or controlled via a delay tolerant protocol over space links which may be via ground based antennas, space based relays/antennas, etc.

Unmanned aerial vehicles (UAVs) encompass a variety of aerial platforms capable of flight without an onboard human pilot. These UAVs can be further classified based on their airframe design, propulsion systems, and operational capabilities. Fixed-wing UAVs feature rigid wings that generate lift through forward airspeed, making them well-suited for long-duration flights, high-altitude operations, and missions requiring extensive coverage, such as environmental monitoring, border surveillance, and mapping. They are typically powered by internal combustion engines or electric motors driving propellers or jet engines and can achieve higher speeds and fuel efficiency compared to other UAV types. Rotary-wing UAVs, such as quadcopters, hexacopters, and octocopters, utilize multiple rotors to achieve vertical takeoff and landing (VTOL) capabilities. These UAVs offer exceptional maneuverability, the ability to hover in place, and the capacity to operate in confined spaces or areas with limited infrastructure. They are ideal for close-range inspections, aerial photography, emergency response, and delivery services in urban environments. Rotary-wing UAVs are generally powered by electric motors supplied by battery systems, balancing flight time with payload capacity. Hybrid VTOL UAVs combine the advantages of fixed-wing and rotary-wing designs by incorporating rotors for vertical takeoff and landing along with fixed wings for efficient horizontal flight. Features described herein can extend their range and endurance while maintaining the versatility of VTOL capabilities. Such UAVs are valuable in missions that require rapid deployment, long-distance travel, and operations from unprepared or restricted areas without runway access.

Unmanned ground vehicles (UGVs) are land-based robots capable of navigating and performing tasks without an onboard human operator. UGVs are designed with various locomotion mechanisms to accommodate different terrains and operational conditions. Wheeled UGVs are efficient on hard surfaces and can achieve considerable speeds, making them suitable for urban patrols, logistics support, and perimeter security. They can be outfitted with advanced sensors, robotic arms, and communication equipment to perform complex tasks autonomously or via remote control. Tracked UGVs utilize continuous tracks that distribute weight and provide enhanced traction and stability on uneven, soft, or rugged terrains. They are ideal for search and rescue operations in disaster-stricken areas, agricultural monitoring over difficult soils, military reconnaissance, and engineering tasks involving heavy loads or towing capacity. Tracked UGVs often feature robust construction, protective housings, and all-weather capabilities. Legged UGVs replicate biological locomotion using articulated legs, offering superior mobility over obstacles, stairs, and irregular environments inaccessible to wheeled or tracked vehicles. These UGVs are beneficial for exploration, inspection of complex industrial structures like pipelines or bridges, and operations in cluttered indoor settings. Advanced models can adapt to varying terrains, maintain balance under disturbances, and interact with the environment using manipulators or sensors mounted on articulated appendages.

Unmanned surface vehicles (USVs) operate on the surface of water bodies, providing autonomous capabilities for maritime applications. USVs range from small craft capable of inland waterway operations to larger vessels designed for open-sea missions. They incorporate propulsion systems such as propellers, water jets, or paddle wheels, powered by electric motors or combustion engines. USVs are equipped with navigation sensors like GPS, inertial measurement units (IMUs), and marine radar to ensure precise maneuvering and collision avoidance. They serve roles in coastal surveillance, environmental monitoring (e.g., water quality assessment, hydrographic surveying), mine countermeasures, and as communication relays or payload delivery platforms.

Unmanned underwater vehicles (UUVs), including autonomous underwater vehicles (AUVs) and remotely operated vehicles (ROVs), are capable of submerged operations in aquatic environments. AUVs perform missions autonomously, following pre-programmed paths and collecting data without real-time human intervention. They are utilized for seabed mapping, oceanographic research, pipeline and cable inspection, and exploration of hazardous environments. UUVs are equipped with sensors such as side-scan sonar, multi-beam echo sounders, magnetometers, and environmental probes to gather comprehensive underwater data. ROVs are tethered submersibles controlled by operators from a support vessel or shore facility. The tether provides power and communication links, enabling real-time video feed, manipulator control, and sensor data transmission. ROVs are commonly used in deep-sea exploration, inspection and maintenance of offshore installations, salvage operations, and scientific research where direct human control is advantageous.

Embodiments of the architecture 100 can interface with any of the above, or any other suitable types of drones 105. Each drone 105 is equipped with an on-board system 130 that enables it to communicate, execute missions, and interact with a fleet management system 120. The drones 105 communicate with multiple transport networks 110, which may include Transport Network A 110-A and Transport Network B 110-B. Although only two transport networks 110 are shown, embodiments can include any suitable number of transport networks 110. These transport networks 110 provide communication pathways between the drones 105 and the fleet management system 120. Transport networks 110 can include cellular networks (e.g., public and/or private cellular networks), satellite networks, fixed optical networks, and other wireless communication infrastructures. Some transport networks 110 can rely on line of sight (LoS) with the drones 105, while others may not. Some transport networks 110 can be public networks. Some transport networks 110 can be private access networks. The ability to utilize multiple transport networks 110 helps to ensure that the drones 105 maintain communication links even when transitioning between different network coverage areas or operating beyond the range of traditional LoS communication systems.

The transport networks 110 communicate with the fleet management system 120. Embodiments of the fleet management system 120 serve as the central hub for controlling, monitoring, and managing the drone 105 fleet.

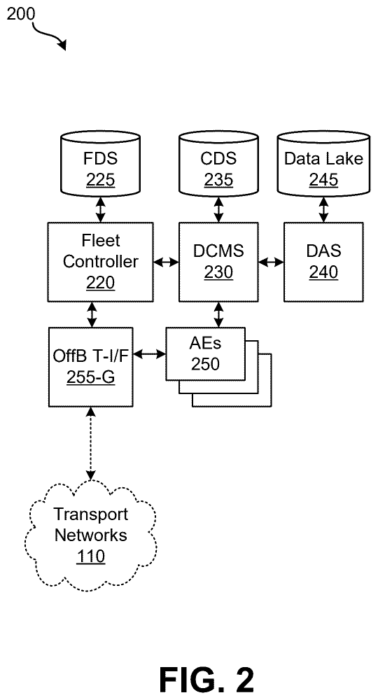

FIG. 2 shows a block diagram of an illustrative fleet management system 200, according to embodiments described herein. The fleet management system 200 can be an implementation of the fleet management system 120 of FIG. 1. As illustrated, the fleet management system 200 includes at least an off-board transport interface (OffB T-I/F) 255-G, a fleet controller 220, a dynamic configuration and management system (DCMS) 230, and a data analytics system (DAS) 240. Embodiments of the fleet management system 200 further include a fleet data store (FDS) 225, a configuration data store (CDS) 235, a data lake 245, and/or one or more autonomous control engines (AEs) 250. The transport networks 110 are shown for context but are not considered part of the fleet management system 200.

Embodiments of the OffB T-I/F 255-G manages communications between the fleet management system 120 and the transport networks 110. For example, it can handle data routing, protocol translation, encryption, and/or other functions to ensure that communication channels are secure and reliable. The interface can be implemented using network gateways, routers, and security appliances configured to support multiple communication protocols and standards.

As used herein, the term “off-board” or “OffB” (e.g., in context of the transport interface) means in a separate entity from the drones of the fleet. In some embodiments, the OffB T-I/F 255-G is implemented as part of a ground-based system. In other embodiments, the OffB T-I/F 255-G is implemented as part of an airborne system, as part of a marine system, or as part of a space-based system. For example, the OffB T-I/F 255-G can be implemented in a control node drone separate from and communicating with the fleet of drones. In one such implementation, the control node drone can represent a “hop” in drone connectivity. For example, the control node drone can offer WiFi-based communications to some or all of the fleet of drones, and the control node drone can then connect (e.g., via SATCOM) to other components of the fleet management system 200.

Embodiments of the fleet controller 220 are responsible for managing the overall operations of the drone 105 fleet. It can handle drone 105 registration and/or authentication and can serve as the network anchor when drones 105 transition between different transport networks. The fleet controller 220 ensures that communication with each drone 105 is maintained and that mission tasks are properly assigned and executed. Some implementations of the fleet controller 220 include a distributed architecture that allows for scalability, supporting the management of large numbers of drones 105 and simultaneous missions. The fleet controller 220 can include a software layer that interfaces with the DCMS 230. For example, the software layer facilitates downloading mission tasks and mission payloads (applications) to the drones 105 and uploading mission data and telemetry received from the drones 105.

Embodiments of the FDS 225 act as a data repository that stores operational data related to the drones 105 and missions. The data can include status information, logs, telemetry data, and/or other relevant operational metrics. The FDS 225 allows the fleet management system 200 to access historical data for analysis, troubleshooting, and optimization of future missions. Embodiments can be implemented using scalable database solutions that support high read/write speeds and secure data storage protocols.

Embodiments of the DCMS 230 operate as a centralized or distributed platform that handles mission and network management. The DCMS 230 is responsible for planning missions, monitoring mission progress, and collecting real-time status updates, statistics, telemetry, and video feeds from the fleet controller 220. The DCMS 230 integrates with AEs 250 to execute missions autonomously and can host drone 105 applications and/or configurations via the CDS 235. Embodiments of the DCMS 230 are implemented using cloud-based platforms that provide high availability and computational resources, as well as edge computing solutions for low-latency applications.

Embodiments of the CDS 235 store applications, configurations, and software updates for the drones 105. The data in the CDS 235 can enable the DCMS 230 to dynamically update drone 105 functionalities by deploying new applications or configurations as needed. The CDS 235 helps to ensure that drones 105 have access to the latest software versions and mission-specific applications. Secure distribution mechanisms and version control systems can be employed to manage the software lifecycle and maintain system integrity. For example, some or all of the drones 105 can be designed to be dynamically reconfigurable to support different types of mission needs by loading different applications, configurations, etc. to the drones 105.

Embodiments of the DAS 240 can ingest and process data collected during missions and/or any other data that may be useful as mission data and/or for dynamic re-tasking, etc. The DAS 240 can be integrated with and/or in communication with the data lake 245. Embodiments utilize artificial intelligence (AI) and/or machine learning (ML) algorithms tailored to specific mission requirements to analyze the data and generate actionable intelligence. The DAS 240 provides analysis results back to the DCMS 230 and AEs 250, informing decision-making and enabling real-time adjustments to missions. Embodiments of the DAS 240 can be implemented by leveraging cloud computing resources for scalable processing power and employing advanced analytics frameworks capable of handling big data and complex models.

Embodiments of the data lake 245 act as a centralized repository that stores all the collected data from missions. It can support large-scale data storage and retrieval, allowing for comprehensive analytics and long-term data retention. The data lake 245 can enable the DAS 240 to access both historical and real-time data, facilitating trend analysis, predictive modeling, and/or continuous improvement of mission strategies. It can be implemented using distributed file systems and scalable storage solutions that provide data redundancy and secure access controls.

Embodiments of the AEs 250 are centralized or distributed systems that generate mission solutions and action plans for the drones 105. The AEs 250 can receive mission plans from the DCMS 230 and can autonomously control drones according to these plans. In some implementations, each AE 250 is associated with autonomously controlling a respective drone 105 (i.e., N AEs 250 for N drones). In other implementations, each AE 250 is responsible for a respective mission, including autonomously controlling one or more drones 105 tasked with carrying out the mission. AEs 250 can collect status updates, video feeds, sensor data, etc. from the drones during a mission. Embodiments of the AEs 250 can also re-task drones dynamically based on the analysis of mission data and/or changes in operational conditions. In some implementations, the AEs 250 can generate alerts if issues or anomalies are detected during missions. Embodiments of the AEs 250 are implemented to include AI-driven control systems capable of real-time decision-making and adaptive mission management.

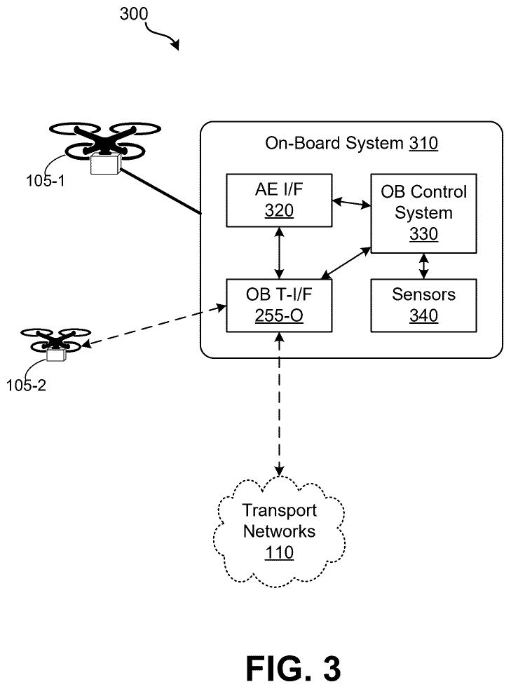

Returning to FIG. 1, each drone 105 has an instance of an on-board system 130. FIG. 3 shows a partial architecture 300 including a block diagram of an illustrative on-board system 310, according to embodiments described herein. The on-board system 310 can be an implementation of the on-board system 130 of FIG. 1. The on-board system 310 is shown as part of a particular drone 105-1. For added context, the partial architecture 300 includes the transport networks 110 and a second drone 105-2.

As illustrated, embodiments of the on-board system 310 include an on-board transport interface (OB T-I/F) 255-O, an autonomous engine interface (AE I/F) 320, an on-board control system 330, and one or more sensors 340. Embodiments of the OB T-I/F 255-O allow the drone 105 to communicate with one or more transport networks 110. It is assumed herein that at least some (e.g., all) of the drones 105 are capable of communicating via the OB T-I/F 255-O with multiple transport networks 110.

Embodiments of the OB T-I/F 255-O support various communication protocols and technologies, such as cellular networks (such as 4G, 5G, etc.), satellite communications (SATCOM), free-space optical (FSO), and/or other wireless systems. Some embodiments of the OB T-I/F 255-O are capable of handling both public and private network infrastructures, line-of-sight (LoS) and non-line-of-sight communication channels, and/or any other suitable types of networks or network links. Embodiments can be implemented using modular hardware components that can be updated or replaced to support new communication standards, multi-SIM (e.g., dual-SIM) capabilities for connecting to multiple cellular networks simultaneously, compatibility with 5G-Non-Terrestrial Networks (5G-NTN) chipsets that enable seamless transitions between terrestrial and satellite networks, etc. The interface ensures that the drone 105 maintains reliable communication links regardless of its location or the operational environment.

Embodiments of the OB T-I/F 255-O include radio frequency (RF) modules, modems, and/or any other components for facilitating communications with one or more of the transport networks 110 over one or more different frequency bands (e.g., VHF, UHF, Ka band, Ku band, etc.). Some embodiments of the OB T-I/F 255-O also support mesh networking capabilities to allow drones 105 to communicate directly with one another. For example, such capabilities facilitate forming ad-hoc networks to extend communication ranges, share data collaboratively, and enhance mission resilience in the event of network failures.

Embodiments of the AE I/F 320 serve as a communication bridge between the drone's 105 on-board control system 330 and the autonomous control engines (AEs) 250 (or a particular AE 250 in some implementations) within the fleet management system 120. The AE I/F 320 allows the drone to receive mission plans, control commands, software updates, and configuration changes from the AEs 250. It also facilitates the transmission of status updates, telemetry data, and other relevant information from the drone 105 back to the AEs 250. The AE I/F 320 can be implemented using standardized communication protocols and secure data transmission methods to ensure interoperability and data integrity.

Embodiments of the on-board control system 330 are responsible for executing mission tasks, controlling the drone's 105 operations, and processing data from various sensors 340. The on-board control system 330 can include processors, memory modules, and software applications to manage navigation, flight control, obstacle avoidance, payload operations, system monitoring, etc. The on-board control system 330 can interact with the AE I/F 320 to receive instructions from the AEs 250 and with the OB T-I/F 255-O to maintain communication with the fleet management system 120. Embodiments can be implemented using embedded systems with real-time operating systems optimized for autonomous operations, including integrating machine learning (ML) algorithms for adaptive behavior, and/or employing fault-tolerant designs for increased reliability.

The drones 105 are illustrated as equipped with one or more sensors 340 to collect data in association with drone 105 operation and/or mission execution. The sensors 340 can include optical cameras for visual imaging, infrared cameras for thermal imaging, radar systems for obstacle detection, LiDAR for mapping and navigation, sonar systems for underwater drones, environmental sensors for detecting temperature, humidity, and chemical agents, specialized payload sensors for specific mission requirements, and/or any other suitable sensors. Data collected by these sensors 340 can be processed on-board and/or transmitted to off-board systems (e.g., the DAS 240) for further analysis. The on-board control system 330 manages the operation of these sensors and ensures that the data is accurately collected and transmitted. Although not explicitly depicted in FIG. 3, the on-board systems 310 can include additional components or mechanisms to support various missions. For example, drones 105 may be equipped with electromechanical arms for manipulation tasks, probes for environmental sampling, cargo compartments for delivery missions, or other specialized equipment depending on the operational needs.

Embodiments of the architecture 100 can interface with any suitable types of drones 105, such as those described above. Each drone 105 can integrate an on-board system 310 customized to its operational needs. The on-board control system 330 within the on-board system 310 governs the primary functionalities of the drone, including mission execution, navigation, propulsion control, sensor data processing, and system health monitoring. For example, for UAVs, the on-board control system 330 manages flight dynamics, including altitude, speed, heading, and stabilization algorithms that adjust control surfaces or rotor speeds in response to environmental conditions and mission parameters. It may incorporate autopilot systems, flight management computers, and redundancy features to enhance reliability and safety. For UGVs, the on-board control system 330 handles locomotion control by adjusting motor outputs to wheels, tracks, or legs, enabling precise movements, obstacle avoidance, and path planning using simultaneous localization and mapping (SLAM) techniques. The system processes data from LiDAR, cameras, ultrasonic sensors, and IMUs to navigate complex terrains and environments. Similarly, the on-board control systems 330 in USVs facilitate effective maritime navigation, propulsion control, and mission task execution. They utilize marine navigation aids, collision avoidance systems, and may include communication protocols specific to maritime operations, such as Automatic Identification System (AIS) compliance. The on-board control system 330 in UUVs can be capable of maintaining depth, heading, and speed while compensating for ocean currents, pressure changes, and other underwater conditions. They execute mission scripts, control payload sensors, and manage power consumption to maximize operational endurance.

Sensors 340 integrated into drones are used for situational awareness, data collection, and mission execution. For example, UAVs can carry electro-optical sensors for high-resolution imaging, hyperspectral cameras for environmental monitoring, synthetic aperture radar (SAR) for all-weather imaging, and communication equipment for network relay or signal intelligence. Advanced UAVs might include detect-and-avoid systems to help avoid collisions with other aircraft and objects. UGVs can be equipped with environmental sensors to detect hazardous substances, radiation levels, or biological agents, supporting roles in hazardous material handling or contamination assessment. They may also utilize ground-penetrating radar for subsurface exploration or payload bays for deploying sensors or equipment. USVs and UUVs can include maritime-specific sensors. USVs may include sonar systems, environmental monitoring sensors (e.g., salinity, temperature), and automated identification systems for maritime traffic management. UUVs can rely on acoustic sensors due to the underwater environment, using sonar for navigation and object detection, and specialized instruments for measuring oceanographic parameters.

Implementations of the drones 105 can be influenced by their power sources, autonomy levels, size, and payload capacities. For example, UAVs can range from small, battery-powered quadcopters weighing a few grams to large, fixed-wing aircraft with wingspans exceeding 20 meters powered by internal combustion engines or hybrid systems. Advances in battery technology, fuel cells, and solar power extend mission endurance and support environmentally friendly operations. UGVs can vary from compact robots designed for indoor environments powered by rechargeable batteries to large, autonomous vehicles for outdoor and off-road missions powered by diesel engines or hybrid systems. Autonomy levels span from teleoperated systems requiring continuous human input to fully autonomous robots making independent decisions based on AI and machine learning algorithms. USVs and UUVs can be designed with hydrodynamic considerations to optimize performance in water. Power systems include electric propulsion for low-speed, silent operations and combustion engines for higher speeds and longer ranges. Autonomous navigation and collision avoidance are critical for safe operation in busy waterways or deep-sea environments.

In some embodiments, the fleet of drones includes refueling and/or recharging drones. Such drones can be in substantially fixed and/or mobile locations and can provide means by which other drones in the fleet can recharge and/or refuel. For example, these drones can include physical ports for delivering electrical charging capacity (e.g., plugs), physical ports coupled with tanks to deliver one or more types of liquid or other fuel, wireless charging ports for non-contact charging, etc. The refueling/recharging drones can be implemented as part of the fleet and can be managed and deployed, as needed, in the ways described herein (e.g., by components of fleet management system 120).

In addition to hardware considerations, software architectures within the on-board control system 330 can be designed to support advanced functionalities like machine learning, adaptive control, and predictive maintenance. Some embodiments of the drones 105 may run embedded operating systems optimized for real-time operation, safety-critical tasks, and resource management. Over-the-air updates enable the fleet management system 120 to deploy new software features, security patches, and performance enhancements without the need for physical access to the drones 105.

Some embodiments of the drones 105 can include energy management features. For example, UAVs and UGVs can incorporate power management systems that monitor battery levels, optimize energy consumption, and manage charging cycles. For solar-powered drones, energy harvesting strategies are employed to extend mission endurance. Fuel-powered drones include fuel level monitoring and efficiency optimization to maximize range.

Embodiments of the drones 105 can also be configured for compliance with safety and/or regulatory standards. For example, UAVs can be designed to adhere to aviation regulations, including airspace restrictions, transponder requirements (e.g., in regions where drone transponder use is allowed), and safety protocols. Drones 105 can incorporate fail-safe mechanisms, redundant systems, and emergency procedures (e.g., return-to-home functions, parachute deployment) to mitigate risks and ensure operational safety.

Returning again to FIG. 1, features of the fleet management system 120 and the on-board system 130 are further described in the context of different types of operational processes, missions, etc. Some of these further descriptions refer to fleet management system 120 components illustrated as part of the fleet management system 200 of FIG. 2, and/or to on-board system 130 components illustrated as part of the on-board system 310 of FIG. 3.

One example of such a feature is mission planning and execution. The DCMS 230 can develop mission plans based on operational requirements. It can coordinate with AEs 250 to generate detailed action plans for the drones 105. The fleet controller 220 can assign mission tasks to individual drones 105, distributing mission payloads and necessary applications through the OB T-I/F 255-O and the transport networks 110. The drones 105 execute the missions autonomously, guided by the on-board control system 330 and instructions received from the AEs 250 via the AE I/F 320.

One example of such a feature is data collection and transmission. During mission execution, drones 105 collect data using their sensors 340. This data, which may include imagery, environmental measurements, system telemetry, etc., can be processed on-board, if needed, and is transmitted back to the fleet management system 120 through the OB T-I/F 255-O and transport networks 110. The fleet controller 220 routes the data to the DCMS 230 and the DAS 240 for off-board processing and analysis.

Another example of such a feature is data processing and analysis. The DAS 240 analyzes the incoming data using AI/ML algorithms. For example, it may perform image recognition to identify objects of interest, detect patterns or anomalies, or generate maps and models from sensor data. The results of the analysis are stored in the data lake 245 and provided to the DCMS 230 and AEs 250 to inform mission adjustments and decision-making processes.

Another example of such a feature is dynamic mission management. Based on the analyzed data and operational needs, the DCMS 230 and AEs 250 can re-task drones in real-time. If new information indicates that mission objectives have changed or that certain areas require more attention, the AEs 250 generate updated action plans. The fleet controller 220 communicates these changes to the drones through the transport networks 110. The drones 105 adjust their missions, accordingly, demonstrating adaptive behavior and responsiveness to changing conditions.

Another example of such a feature is multi-transport communication. The OB T-I/F 255-O and OffB T-I/F 255-G enable seamless communication across multiple transport networks. For instance, if a drone moves out of the coverage area of a cellular network, it can switch to a satellite network (or another cellular network) without losing connection to the fleet management system 120. The fleet controller 220 facilitates this network transition by serving as a network anchor, ensuring that communication sessions remain uninterrupted.

Another example of such a feature is vendor-agnostic integration. Embodiments of the architecture 100 are designed to be drone vendor-agnostic. By utilizing standardized interfaces and communication protocols, the system can integrate drones 105 from different manufacturers. The fleet controller 220 translation abilities, such as application programming interfaces (APIs), allow the fleet management system 120 to communicate with various drone 105 models without compatibility issues.

As one illustrative use case, the architecture 100 is used to perform coastal monitoring. In this use case, a fleet of drones 105 is deployed along the coastline to monitor maritime activities, environmental conditions, and provide assistance to vessels as needed. The drones 105 are equipped with the on-board system 130, including sensors 340 such as high-resolution cameras, infrared sensors, and radar systems to detect and track objects. As drones 105 operate along the coast, they communicate with terrestrial cellular networks (Transport Network A 110-A) via the OB T-I/F 255-O. When a drone 105 needs to extend its mission beyond visual line-of-sight to inspect or assist a fishing boat located further offshore, it seamlessly transitions to satellite communication (Transport Network B 110-B) using SATCOM capabilities integrated into the OB T-I/F 255-O.

The fleet controller 220 and the DCMS 230 coordinate this network transition by updating the drone's 105 communication parameters and ensuring that encryption and authentication protocols are maintained. The AE I/F 320 allows the drone to receive updated mission instructions from the AEs 250, which may include new waypoints, task priorities, or sensor configurations. Data collected by the drone 105 is transmitted back to the fleet management system 120, where the DAS 240 processes it in real-time. If the DAS 240 detects any anomalies, such as an unexpected vessel or environmental hazard, it alerts the DCMS 230 and AEs 250. The AEs 250 may then re-task the drone 105 or deploy additional or different drones 105 to investigate further.

As another illustrative use case, the architecture 100 is used to carry out a surveillance mission with data analytics integration. In this scenario, multiple drones 105 are tasked with conducting surveillance over a specified area, such as a critical infrastructure facility. The drones 105 are autonomously controlled by the AEs 250, which have received mission plans from the DCMS 230 detailing the surveillance objectives, flight paths, and data collection requirements. As the drones 105 execute their mission, they collect high-definition video, thermal imagery, and other sensor data using their sensors 340. This data is streamed in real-time via the OB T-I/F 255-O and transport networks 110 to the DAS 240.

The DAS 240 utilizes advanced AI/ML algorithms to process the incoming data. For example, it may perform facial recognition to identify personnel, detect unauthorized access, or monitor equipment performance. Analysis results are promptly sent back to the AEs 250 and the DCMS 230. Based on the insights from the DAS 240, the AEs 250 may decide to re-task certain drones 105. For instance, if an anomaly is detected in a specific area, the AEs 250 can adjust the flight paths of nearby drones 105 to focus on that location. The drones 105 receive these new instructions via the AE I/F 320 and adjust their operations accordingly. The ability to process data off-board allows for more complex analytics without burdening the drones' 105 on-board systems, and dynamic mission management can enhance operational efficiency.

As another illustrative use case, the architecture 100 is used for dynamic re-tasking based on data analytics. In this use case, the DCMS 230 receives a new mission directive, such as a change in priority areas for surveillance due to emerging intelligence. Simultaneously, the DAS 240 may analyze data indicating unusual activity in a certain region. The DCMS 230 determines that re-tasking is necessary and identifies which drones 105 are best suited for the updated mission based on their current location, sensor capabilities, and operational status. It also assesses the required transport networks for effective communication, especially if drones 105 need to operate beyond LoS.

The fleet controller 220 communicates the relevant information to the drones 105 through the OB T-I/F 255-O and transport networks 110. This includes updated mission plans, configuration changes, and any necessary application updates from the CDS 235. The AEs 250 autonomously control the drones 105 according to the new mission parameters. Drones 105 receive the new instructions via the AE I/F 320 and adjust their operations, demonstrating the system's ability to rapidly adapt to changing mission requirements based on data-driven insights.

As another illustrative use case, the architecture 100 is used for battery management and drone replacement. Drones 105 continuously monitor their operational status through the on-board control system 330, which includes tracking battery levels. When a drone 105 detects that its battery is reaching a critical level, it communicates this information to the AEs 250 via the AE I/F 320 and transport networks 110. The AEs 250, upon receiving this notification, coordinate with the DCMS 230 to ensure mission continuity. They identify a replacement drone 105 that is available and capable of assuming the ongoing tasks. The DCMS 230 updates the mission plan to include the replacement drone 105.

The fleet controller 220 communicates the new instructions to both the returning drone 105 and the replacement drone 105. The returning drone 105 is guided back to a designated charging or maintenance station, while the replacement drone 105 is dispatched to continue the mission without interruption. This process involves seamless coordination between the drones 105, AEs 250, DCMS 230, and the fleet controller 220, leveraging real-time data and autonomous decision-making to maintain operational efficiency and mission effectiveness.

As another illustrative use case, the architecture 100 is used for collaborative imaging and processing. This scenario involves multiple drones 105 working collaboratively to capture complex imagery data for applications such as 3D mapping, environmental monitoring, or infrastructure inspection. Each drone 105 may be equipped with different sensors 340, such as optical cameras, infrared sensors, and LiDAR systems. The drones 105 are coordinated by the AEs 250, which have generated a mission plan that optimizes their flight paths and sensor usage to collectively gather comprehensive data. The drones 105 communicate with each other and the fleet management system 120 via the OB T-I/F 255-O and transport networks 110.

Data collected by each drone 105 is transmitted to the DAS 240, where it is processed collectively. The DAS 240 combines the multi-sensor data to generate detailed models, such as 3D reconstructions of terrain or structures, or to perform multi-spectral analysis for environmental assessments. Off-board processing allows for handling large datasets and employing complex AI/ML models that would be impractical to run on the drones themselves. The results are provided back to the DCMS 230, which can adjust mission parameters or advise operators based on the enhanced data.

As another illustrative use case, the architecture 100 is used for disaster response. In a disaster response scenario, drones 105 are rapidly deployed to assess damage, locate survivors, and assist in rescue operations. The operational environment may involve compromised infrastructure, requiring the drones to utilize multiple transport networks 110 to maintain resilient communication, such as switching between cellular networks and SATCOM. The DCMS 230 quickly develops mission plans tailored to the disaster area, coordinating with AEs 250 to dispatch drones equipped with appropriate sensors 340, such as thermal cameras for locating heat signatures of survivors.

Data collected by the drones 105 is transmitted in real-time to the DAS 240, which processes the information to identify areas of concern, such as collapsed structures or fires. The DAS 240 provides actionable intelligence to first responders through the DCMS 230. The architecture's 100 ability to operate in challenging conditions, utilize multi-transport communication, and provide rapid data analysis significantly enhances the effectiveness of disaster response efforts. Dynamic mission management allows for continuous adaptation as the situation evolves.

The descriptions above refer in several places to using artificial intelligence and/or machine learning (AI/ML). For example, embodiments of the architecture of any of FIG. 1-3 can use AI/ML capabilities to enhance various components, such as within the DAS 240, the AEs 250, and the on-board control systems 330 of the drones 105. These AI/ML implementations can enable real-time data processing, adaptive decision-making, and dynamic mission management, and/or other features to improve operational efficiency and mission outcomes.

Turning to the DAS 240, advanced AI/ML algorithms can be used to process and analyze the vast amounts of data collected by the drones 105. This includes images, videos, sensor readings, telemetry data, and environmental information. AI/ML applications within the DAS 240 can be used for image and video analysis. For example, the DAS 240 can include deep learning models, such as convolutional neural networks (CNNs), generative adversarial networks (GANs), and/or other networks to perform image and video recognition tasks. Models such as ResNet, VGGNet, or Inception can be used for object detection, classification, and segmentation. As one example, in surveillance missions, such models can aid in identifying unauthorized personnel or vehicles by analyzing video feeds in real-time. Such models can be trained using supervised learning, where large labeled datasets of images are used to teach the model to recognize specific objects or patterns. The training data may include thousands of images with annotations indicating the objects of interest. Data augmentation techniques, such as rotation, scaling, and flipping, can enhance the dataset's diversity and help prevent overfitting.

AI/ML applications within the DAS 240 can also be used for sensor data interpretation. For interpreting data from various sensors like LiDAR, radar, and infrared cameras, recurrent neural networks (RNNs) or long short-term memory networks (LSTMs) can be utilized. These models are effective for sequential data and can detect temporal patterns or changes over time. An example application is anomaly detection in environmental monitoring, where the system analyzes sensor data streams to identify deviations from normal patterns, such as sudden temperature changes or unusual chemical readings.

AI/ML applications within the DAS 240 can also be used for anomaly detection and predictive analytics. Unsupervised learning algorithms, such as autoencoders or clustering methods like K-means, can detect anomalies without explicit labels. These models learn the normal operational patterns and flag any deviations that might indicate faults or threats. Predictive analytics employs supervised learning models like support vector machines (SVMs), decision trees, or ensemble methods like random forests to forecast future events or states. For example, predicting equipment failures based on historical telemetry data allows for proactive maintenance scheduling.

AI/ML applications within the DAS 240 can also be used for natural language processing (NLP), symbol analysis, or the like. NLP models can process textual data collected during missions or communications. Techniques like transformer-based models (e.g., BERT, GPT) enable the system to understand and generate human language, facilitating better interaction between human operators and the system. The training data for these models come from the data lake 245, which stores historical mission data and operational records. Data preprocessing steps, such as cleaning and normalization, are crucial to ensure data quality. Additionally, transfer learning can be used to adapt pre-trained models to specific mission contexts, reducing the amount of domain-specific data required.

Turning to the AEs 250, AI/ML applications can be used to generate mission solutions, optimize drone tasking, make real-time adjustments based on operational data, etc. For example, AI/ML applications can be used for reinforcement learning (RL) for mission planning. RL algorithms enable the AEs 250 to learn optimal strategies through trial and error interactions with a simulated environment. Algorithms like Deep Q-Networks (DQNs), Proximal Policy Optimization (PPO), or Asynchronous Advantage Actor-Critic (A3C) can be used. In training, the AE 250 interacts with a simulation that models the operational environment. The AE 250 receives a reward signal based on the success of its actions, such as efficient completion of mission objectives or conservation of resources. Over time, the AE 250 learns policies that maximize cumulative rewards.

AI/ML applications within the AEs 250 can also be used for swarm intelligence for drone coordination. For missions involving multiple drones 105 working collaboratively, swarm intelligence algorithms like Particle Swarm Optimization (PSO) or Ant Colony Optimization (ACO) can be used. These algorithms simulate the collective behavior of decentralized, self-organized systems, allowing drones 105 to coordinate without centralized control. Training involves using simulations to model drone interactions and environmental responses. The AEs 250 learn rules and behaviors that result in efficient task execution, such as area coverage or target tracking.

AI/ML applications within the AEs 250 can also be used for supervised learning for predictive maintenance. By analyzing historical maintenance data and operational telemetry, supervised learning models can predict when a drone 105 or its components might fail. Models like logistic regression or gradient boosting machines can identify patterns indicative of impending failures. Training data includes labeled records of drone 105 performance metrics and maintenance events. The model learns to associate certain telemetry patterns with failures, enabling the AE 250 to schedule maintenance proactively.

AI/ML applications within the AEs 250 can also be used for optimization algorithms for resource allocation. The AEs 250 can use AI-driven optimization algorithms to allocate resources effectively. Linear programming, integer programming, or evolutionary algorithms can optimize factors like drone 105 assignments to tasks, scheduling, and route planning. These AI/ML models are trained using data from simulations, historical missions, and real-time feedback from operations. The models continuously improve through online learning mechanisms, adapting to new scenarios and data patterns.

Turning to on-board control systems 330, AI/ML applications can be used to enhance autonomy, navigation, and decision-making capabilities, etc. For example, AI/ML applications can be used for computer vision for obstacle avoidance. Lightweight CNNs can run on embedded hardware to process visual data from cameras. Object detection models like YOLO (You Only Look Once) or SSD (Single Shot MultiBox Detector) can identify obstacles in real-time, enabling the drone 105 to navigate around them safely. These models are trained using supervised learning with datasets comprising images of various obstacles annotated with bounding boxes or segmentation masks. Techniques like pruning and quantization reduce model size for deployment on resource-constrained devices.

AI/ML applications within the on-board control systems 330 can also be used for SLAM (Simultaneous Localization and Mapping). Drones 105 use SLAM algorithms for navigation in unknown environments. Integrating AI, the system can use deep learning-based feature extraction to improve map accuracy. Models like DeepVO (Deep Visual Odometry) enable the drone to estimate its motion from sequential camera images. Training involves sequences of images with corresponding ground truth poses, allowing the model to learn visual cues associated with movement.

AI/ML applications within the on-board control systems 330 can also be used for adaptive control systems. Neural network-based control algorithms can adjust flight control parameters dynamically. For example, reinforcement learning can enable the drone 105 to learn optimal control actions in response to environmental changes like wind gusts. Training is performed in simulated environments where a drone model interacts with a virtual environment, learning control strategies that maximize stability and performance.

AI/ML applications within the on-board control systems 330 can also be used for fault detection and diagnosis. On-board AI algorithms can monitor the drone's 105 systems to detect anomalies or faults. Unsupervised learning methods like clustering or one-class SVMs can identify abnormal patterns in sensor data indicative of mechanical issues. Training data consists of normal operational sensor readings, allowing the model to recognize deviations that may signal a problem.

The various AI/ML models can be trained with extensive and diverse datasets. For example, for image and video models, datasets can include labeled images and videos representing various objects, terrains, and environmental conditions. Sources can be from previous missions, public datasets, and synthetic data generated through simulation. Sensor data models can use time-series data from sensors like accelerometers, gyroscopes, LiDAR, and radar. Preprocessing steps include normalization and noise reduction. For reinforcement learning, simulated environments can replicate real-world physics and operational scenarios. Data augmentation and synthesis can use techniques to expand the datasets, such as by adding noise, transformations, or synthetic data, thereby helping models generalize better.

Deploying AI/ML models within the architecture (such as in FIG. 2) can involve several considerations. Some implementations use edge computing. For example, on-board models are optimized for low latency and minimal resource usage. Techniques include model compression, using half-precision floating-point numbers, and efficient network architectures. Some implementations use cloud computing. For example, the DAS 240 and AEs 250 utilize cloud resources for heavy computational tasks. Scalable infrastructure like GPU clusters and distributed computing frameworks facilitate handling large datasets and complex models. Some implementations are configured to support online learning and model updates based on new data, for example to ensure that models remain accurate over time and adapt to changing environments. Some implementations also support security and integrity, such as including encryption and authentication, prevention of unauthorized access and tampering, etc. Regular audits and validation checks can be used to maintain model integrity.

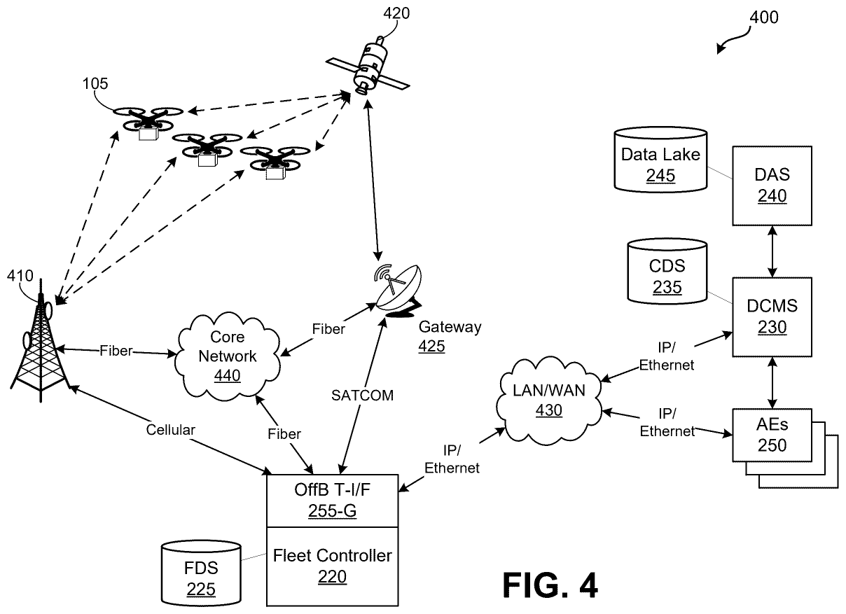

FIG. 4 illustrates a network architecture 400 depicting illustrative transport networks and communication pathways within a multi-transport drone fleet management system, according to embodiments described herein. The architecture 400 can represent an implementation of the architecture 100 of FIG. 1. The illustrated architecture 400 includes two distinct transport networks 110. The first transport network (e.g., corresponding to Transport Network A 110-A of FIG. 1) is represented by cell tower 410 and may be a terrestrial public or private cellular network providing communication services to the drones 105. The second transport network (e.g., corresponding to Transport Network B 110-B of FIG. 1) is depicted by the gateway 425 and satellite 420. Satellite 420 can be in low earth orbit (LEO), medium earth orbit (MEO), or geosynchronous orbit (GEO). For example, the second transport network may be a separate satellite communication network, a satellite portion of a 5G-Non-Terrestrial Network (5G-NTN) deployment, etc. One or both of these transport networks may be coupled with the core network 440, facilitating centralized management and data routing between components of the fleet management system and the drones 105.

As described with reference to FIG. 2, a fleet management system (e.g., fleet management system 200) can include an off-board transport interface (OffB T-I/F) 255-G, a fleet controller 220, a DCMS 230, and a DAS 240. Some embodiments further include one or more AEs 250. Some embodiments can also include one or more data stores, such as the FDS 225, CDS 235, and/or data lake 245. As illustrated, the OffB T-I/F 255-G provides an interface between the fleet controller 220 and the transport networks. For example, the OffB T-I/F 255-G communicates with towers 410 of the cellular network and with gateways 425 of the satellite network directly and/or via the core network 440. Embodiments of the OffB T-I/F 255-G can also provide an interface between the fleet controller 220 and other public and/or private networks, such as local area networks and/or wide area networks, illustrated as LAN/WAN 430. In some implementations, LAN/WAN 430 is or includes the Internet.

The core network 440, when coupled with one or both transport networks 110, can facilitate centralized management of data routing and communications between the fleet management system 120 components. Components such as the fleet controller 220, the DCMS 230, the DAS 240, and any AEs 250 can be interconnected via IP/Ethernet connections, or any other suitable communication links, allowing for high-speed and reliable data exchange. The data stores, including the CDS 235, FDS 225, and the data lake 245 can be integrated within other components of the fleet management system, in direct communication with those components, accessible via cloud infrastructures, and/or accessible in any other suitable manner. For example, the some or all of the DCMS 230, DAS 240, AEs 250, CDS 235, and data lake 245 can be implemented on cloud-based servers accessible to the fleet controller 220 via the LAN/WAN 430.

Drones 105 can be located in locations outside of Earth, such as in outer space. It is also possible that one or more of drones 105 be located on the moon or another planet, such as Mars. A delay-tolerant communication protocol would be used to control such drones via one or more communication links that make use of ground-based antennas and/or space-based antennas.

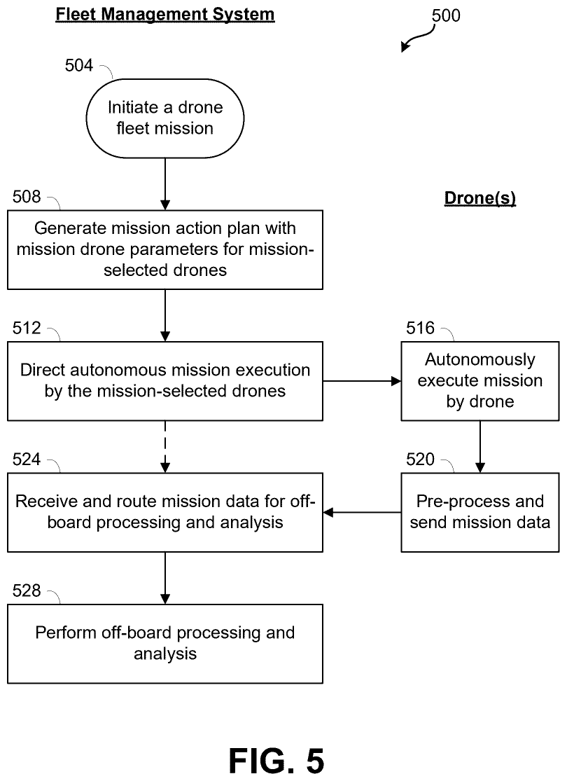

FIG. 5 shows a flow diagram of a method 500 for fleet deployment and data processing in an autonomous multi-domain drone fleet management architecture, according to embodiments described herein. Embodiments begin at stage 504, during a drone fleet deployment, when the fleet management system 120 initiates the mission by coordinating the drones 105 through the fleet controller 220. At stage 508, embodiments (e.g., the DCMS 230) send mission parameters and objectives (e.g., to AEs 250) to generate detailed action plans for each drone 105. In stage 512, embodiments communicate the action plans to the drones 105. For example, the communication is via the OffB T-I/F 255-G and the appropriate transport network 110.

At stage 516, the drones 105 execute the mission autonomously, with their on-board control systems 330. For example, on-board systems of the drones 105 can manage flight operations, collect sensor data using the sensors 340, etc. At stage 520, data collected by the drones 105 (e.g., high-resolution images, environmental measurements, telemetry information, etc.) can be processed as needed by the on-board control systems 330 and transmitted back to the fleet management system 120 (e.g., via the OB T-I/F 255-O) using available transport networks 110.

In stage 524, embodiments receive and route the data for off-board data processing, storage, and/or analytics. For example, the data is received by the fleet controller 220 and routed to the DAS 240. At stage 528, embodiments perform off-board data processing, storage, and/or analytics. For example, the DAS 240 ingests the data into the data lake 245 for storage and further analysis; and utilizing advanced AI/ML algorithms, the DAS 240 processes the sensor information to generate actionable insights, which are then provided to the DCMS 230 and AEs 250 to inform real-time decision-making and potential mission adjustments.

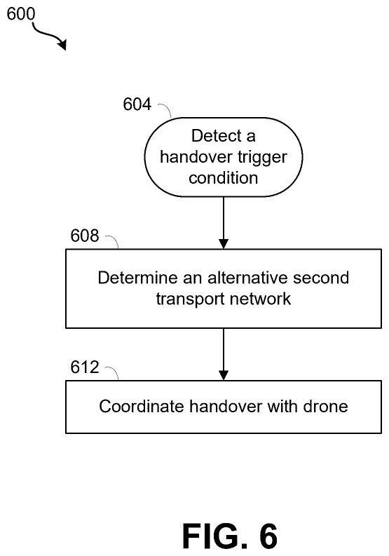

FIG. 6 shows a flow diagram of a method 600 for transport network transitioning in an autonomous multi-domain drone fleet management architecture, according to embodiments described herein. In some cases, the method 600 can occur during execution of a mission involving a fleet of one or more drones 105, such as concurrent with execution of the method 500 of FIG. 5. Embodiments of the method 600 assume that, upon invoking the method 600, the drone 105 is communicating with at least an AE 250 or other components of the fleet management system via a first transport network. Further, some condition arises in which the drone 105 encounters conditions necessitating a change in transport networks. This condition can be referred to as a handover trigger. For example, the drone moves out of range of a terrestrial cellular network, out of line-of-sight of an LoS network, etc.

At stage 604, embodiments can detect the handover trigger condition. For example, the drone 105 can detect using its OB T-I/F 255-O weakening signal strength between the drone 105 and the first transport network. Alternatively, one or more components of the fleet management system can detect the handover trigger condition. At stage 608, embodiments can identify an alternative second transport network that is available and with which the drone 105 is compatible. For example, the second transport network can be a satellite network. In some cases, the handoff trigger condition and/or the selection of the alternative second transport network considers additional information. As one example, it is desirable to offload sensitive drone data only on a predetermined subset of available networks (e.g., a private, encrypted 5G network), even if data can be stored on-board the drone while it is on a public network. In general, different networks may have different data costs, bandwidths, security, latency, etc.; and those and/or other factors may be considered.

In stage 612, embodiments coordinate with the drone 105 to seamlessly hand over drone 105 communications from the first transport network to the second transport network. In some embodiments, the on-board control system 330 of the drone 105 communicates a relevant change in network status (e.g., the weakened signal) and/or another relevant change (e.g., a location of the drone 105) to the fleet controller 220 via the first transport network, the relevant change indicating the need to switch transport networks. In some such embodiments, the fleet controller 220, acting as a network anchor, facilitates the authentication and transition process by using the OffB T-I/F 255-G to manage the connection parameters and ensure secure communication is maintained. The drone 105 can then be seamlessly transitioned (handed over) to the second transport network without interrupting mission execution. For example, mission data and telemetry continue to flow between the drone 105 and the fleet management system 120 without interruption, including maintaining continuous communication between the drone 105 and the DCMS 230 and AEs 250. In some embodiments (or as needed), drones can be implemented to buffer data on board during handover to ensure data is not lost during the handover process.

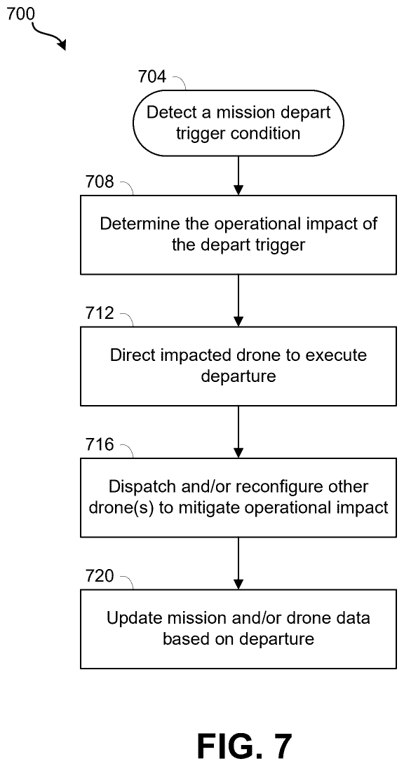

FIG. 7 shows a flow diagram of a method 700 for executing a predetermined mission departure in an autonomous multi-domain drone fleet management architecture, according to embodiments described herein. In some cases, the method 700 can occur during execution of a mission involving a fleet of one or more drones 105, such as concurrent with execution of the method 500 of FIG. 5. Embodiments begin at stage 704, when a trigger event is detected indicating that a drone 105 must depart from the mission due to factors, such as low battery levels or on-board system damage. In some implementations, the on-board control system 330 monitors critical parameters and, upon reaching a predefined threshold (e.g., battery level drops below 15%), sends a status update to an AEs 250 via the OB T-I/F 255-O and the current transport network 110. In other implementations, an AE 250 or other fleet management system component detects the trigger event.

In stage 708, embodiments evaluate the operational impact of the trigger event. For example, the fleet management system (e.g., the AE 250) receives a trigger event notification and evaluates the operational impact, communicating with the DCMS 230 to update the mission plan and ensure that the drone's 105 tasks are reassigned if necessary. At stage 712, embodiments provide the drone 105 with new instructions, such as directing it to return to a designated recharging station or safe location, to self-destruct, etc.

Optionally, at stage 716, embodiments (e.g., using the DCMS 230) can dispatch a replacement drone 105 to continue the mission. For example, the replacement drone 105 can be a previously untasked drone 105, a re-tasked drone, etc. The coordinating of the new drone 105 can be handled through the fleet controller 220 and OffB T-I/F 255-G. In some embodiments, at stage 720, data regarding the departure and/or replacement is logged. For example, relevant data can be logged in the FDS 225 and/or the CDS 235 for record-keeping, post-mission analysis, etc.

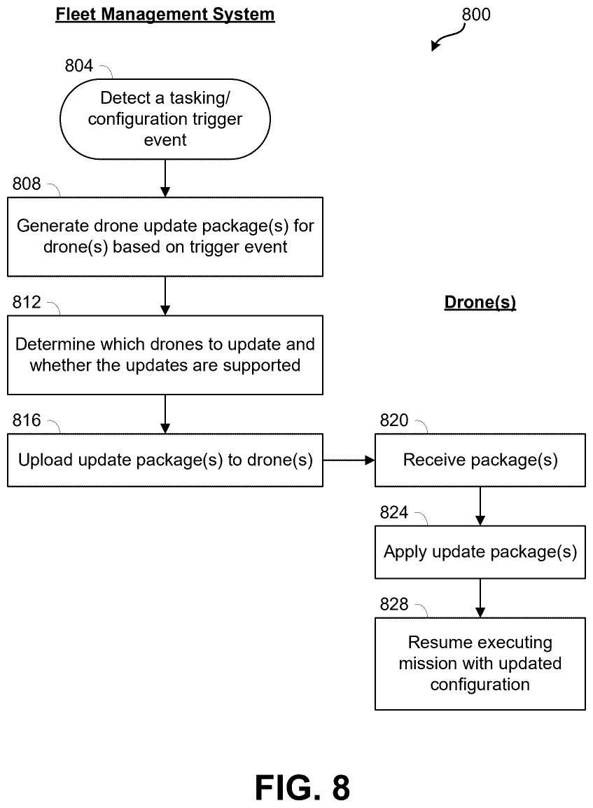

FIG. 8 shows a flow diagram of a method 800 for drone tasking, re-tasking, and/or reconfiguration in an autonomous multi-domain drone fleet management architecture, according to embodiments described herein. In some cases, the method 800 can occur during execution of a mission involving a fleet of one or more drones 105, such as concurrent with execution of the method 500 of FIG. 5. Embodiments begin at stage 804 by detecting a tasking or reconfiguration trigger event. For example, the DCMS 230 or an AE 250 can determine that a new or updated drone 105 configuration, a new or updated drone 105 application, a new or updated on-board algorithm, and/or the like is needed to support new intelligence, new or changing mission requirements, etc.

At stage 808, embodiments generate one or more drone 105 update packages for one or more selected drones 105. For example, the DCMS 230 retrieves update files, etc. from the configuration data store (CDS 235). At stage 812, some embodiments determine whether a particular drone 105, or which drones 105 in the fleet support receipt of the update package. For example, data from the FDS 225, AEs 250, and/or other sources can be used to indicate a present configuration of a drone 105, present applications on-board a drone 105, what types of applications and/or other capabilities are supported by a drone 105, whether a drone 105 is presently in a status (e.g., sufficient battery, sufficient storage capability, sufficient signal strength, secure transmission link, etc.) to support receipt of the update packages.

At stage 816, embodiments upload the update package(s) to the selected one or more drones 105. For example, the DCMS 230 packages the new configuration or application and sends it to the fleet controller 220, and the fleet controller 220 uses the OffB T-I/F 255-G to transmit the update to the drone 105 via a present (or most reliable) transport network 110.

In some embodiments, at stage 820, the drone 105 receives the update package and forwards it to relevant component of its on-board system. For example, the OB T-I/F 255-O on the drone 105 receives the update via the transport network 110 and passes it to the on-board control system 330. In some such embodiments, at stage 824, the drone 105 applies the update package to execute a drone 105 reconfiguration. For example, the on-board control system 330 safely applies the new configuration or installs the updated application, potentially restarting certain subsystems while ensuring that critical functions remain operational. In some embodiments, at stage 828, the drone 105 resumes its mission with the updated capabilities. For instance, during a wildfire monitoring operation, if drones need to shift from visual imaging to thermal imaging algorithms to detect hotspots at night, this reconfiguration process enables that transition efficiently without relying on all algorithms and applications for both capabilities being concurrently stored by the drones 105 from the start.

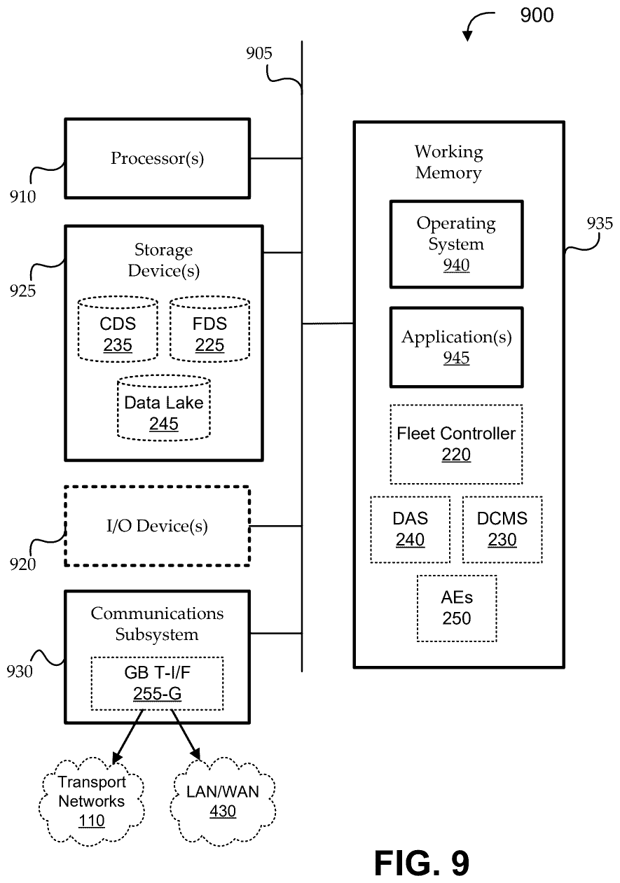

In some embodiments, components of the fleet management system, and/or components thereof, are implemented by a computational system. FIG. 9 provides a schematic illustration of an embodiment of a computational system 900 that can implement various system components and/or perform various steps of methods provided by various embodiments. FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computational system 900 is shown including hardware elements that can be electrically coupled via a bus 905 (or may otherwise be in communication, as appropriate). The hardware elements may include one or more processors 910, including, without limitation, one or more general-purpose processors and/or one or more special-purpose processors (such as digital signal processing chips, graphics acceleration processors, video decoders, and/or the like). Optionally, embodiments of the computational system 900 can include one or more input and/or output (I/O) devices 920. The I/O devices 920 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports); user output devices (e.g., display devices, printers, and/or the like); and/or machine I/O devices (e.g., computer-to-computer interfaces, such as wired and/or wireless output data ports).

The computational system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some implementations, the storage devices 925 include the fleet data store (FDS) 225, the configuration data store (CDS) 235, and/or the data lake 245.

The computational system 900 can also include a communications subsystem 930, which can include, without limitation, a modem, a network card (wireless or wired), an infrared communication device, a wireless communication device, a chipset, and/or the like. As illustrated, embodiments of the communications subsystem 930 include the off-board transport interface, which can be in communication with transport networks 110 and, in some implementations, with one or more other networks (e.g., LAN/WAN 430).

The computational system 900 further includes a working memory 935, which can include a RAM or ROM device, as described herein. The computational system 900 also can include software elements, shown as currently being located within the working memory 935, including an operating system 940, device drivers, executable libraries, and/or other code, such as one or more application programs 945, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 940 and the working memory 935 can be used in conjunction with the one or more processors 910 to implement the some or all of the features of the fleet controller 220, dynamic configuration and management system (DCMS) 230, data analytics system (DAS) 240, and/or autonomous engines (AEs) 250.

A set of these instructions and/or codes can be stored on a non-transitory (or non-transient) computer-readable storage medium, such as the non-transitory storage device(s) 925 described above. In some cases, the storage medium can be incorporated within a computer system, such as computational system 900. In other embodiments, the storage medium can be separate from a computer system (e.g., a removable medium, such as a USB drive), and/or provided in an installation package, such that the storage medium can be used to program, configure, and/or adapt a general-purpose computer with the instructions/code stored thereon. These instructions can take the form of executable code, which is executable by the computational system 900 and/or can take the form of source and/or installable code, which, upon compilation and/or installation on the computational system 900 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 900) to perform methods in accordance with various embodiments of the invention. In some embodiments, the non-transitory storage device(s) 925 has instructions stored thereon, which, when executed, cause the processor(s) 910 to perform steps of any of the methods 500-800 of FIG. 5-8. According to a set of embodiments, some or all of the procedures of such methods are performed by the computational system 900 in response to processor 910 executing one or more sequences of one or more instructions (which can be incorporated into the operating system 940 and/or other code, such as an application program 945) contained in the working memory 935. Such instructions may be read into the working memory 935 from another computer-readable medium, such as one or more of the non-transitory storage device(s) 925. Merely by way of example, execution of the sequences of instructions contained in the working memory 935 can cause the processor(s) 910 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 900, various computer-readable media can be involved in providing instructions/code to processor(s) 910 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 925. Volatile media include, without limitation, dynamic memory, such as the working memory 935. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a disk of a remote computer. The remote computer can load the instructions into its dynamic memory and send the instructions as signals over a transmission medium to be received and/or executed by the computational system 900. The communications subsystem 930 (and/or components thereof) generally will receive signals, and the bus 905 then can carry the signals (and/or the data, instructions, etc., carried by the signals) to the working memory 935, from which the processor(s) 910 retrieves and executes the instructions. The instructions received by the working memory 935 may optionally be stored on a non-transitory storage device 925 either before or after execution by the processor(s) 910.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A drone fleet management system comprising:
an off-board transport interface configured to communicate over multiple transport networks, wherein the off-board transport interface is distinct from a fleet of unmanned vehicles;
a fleet controller in communication with the off-board transport interface and configured to manage operations of the fleet of unmanned vehicles, each unmanned vehicle equipped with an on-board system including an on-board transport interface configured to communicate over the multiple transport networks; and
a dynamic configuration and management system (DCMS) in communication with the fleet controller and configured to develop mission plans for the fleet of unmanned vehicles and coordinate with autonomous engines to generate action plans for autonomous execution of the mission plans by the fleet of unmanned vehicles.

2. The drone fleet management system of claim 1, further comprising:
the autonomous engines in communication with the DCMS and in communication with the fleet of unmanned vehicles via the off-board transport interface.

3. The drone fleet management system of claim 1, wherein the off-board transport interface performs switching between a satellite communication network and a cellular communication network.

4. The drone fleet management system of claim 1, further comprising:
a data analytics system in communication with the DCMS and configured to perform real-time, off-board processing of mission data collected by the fleet of unmanned vehicles.

5. The drone fleet management system of claim 4, further comprising:
a data lake in communication with the data analytics system and configured to store the mission data collected by the unmanned vehicles.

6. The drone fleet management system of claim 4, wherein the data analytics system is further configured to use artificial intelligence and machine learning (AI/ML) to generate actionable insights from the processed data.

7. The drone fleet management system of claim 4, wherein the data analytics system is further configured to generate, from the processed data, one or more of a handover trigger, a mission depart trigger, or a tasking/configuration trigger event.

8. The drone fleet management system of claim 1, wherein the DCMS is further configured to:
detect a handover trigger associated with one or more of the unmanned vehicles presently communicating over a first of the multiple transport networks; and
responsive to detecting the handover trigger, determine a second of the multiple transport networks that is available for use in communication with the one or more of the unmanned vehicles, and direct handover of the one or more of the unmanned vehicles from the first of the multiple transport networks to the second of the multiple transport networks.

9. The drone fleet management system of claim 1, wherein the DCMS is further configured to:
detect a mission depart trigger associated with one or more of the unmanned vehicles presently performing autonomous execution of the mission plans; and
responsive to detecting the mission depart trigger, direct the one or more of the unmanned vehicles to execute a corresponding mission depart sequence.

10. The drone fleet management system of claim 9, wherein the DCMS is further configured, responsive to receiving the mission depart trigger, to:
determine an operational impact of executing the corresponding mission depart sequence; and
direct deployment of one or more others of the fleet of unmanned vehicles to at least partially address the operational impact.

11. The drone fleet management system of claim 1, wherein the DCMS is further configured to:
detect a tasking/configuration trigger event associated with one or more of the unmanned vehicles; and
responsive to detecting the tasking/configuration trigger event, determine a stored drone configuration or drone application corresponding to the tasking/configuration trigger event, and direct uploading of the stored drone configuration or drone application to the one or more of the unmanned vehicles to reconfigure one or more mission capabilities of the one or more of the unmanned vehicles.

12. The drone fleet management system of claim 1, further comprising:
a fleet data store in communication with the fleet controller and configured to store operational data related to the unmanned vehicles and missions.

13. The drone fleet management system of claim 1, further comprising:
a configuration data store in communication with the DCMS and configured to store drone configurations and/or drone applications, which, when uploaded to and executed by at least one of the on-board systems of at least one of the unmanned vehicles, reconfigures one or more mission capabilities of the at least one of the unmanned vehicles.

14. The drone fleet management system of claim 1, wherein the fleet controller comprises a translation engine configured to concurrently manage operations of a plurality of unmanned vehicles of the fleet of unmanned vehicles, wherein the plurality of unmanned vehicles uses different vendor-specific communications.

15. The drone fleet management system of claim 1, wherein a first of the multiple transport networks is a line-of-sight (LoS) network, and a second of the multiple transport networks is a beyond LoS network.

16. The drone fleet management system of claim 1, wherein a first of the multiple transport networks is a first cellular network, and a second of the multiple transport networks is a second cellular network or a satellite network.

17. A system for automated multi-domain drone fleet management, the system comprising:
one or more processors;
an off-board transport interface configured to communicate with a fleet of unmanned vehicles over multiple transport networks;
a non-transitory memory having instructions stored thereon which, when executed, cause the one or more processors to perform steps comprising:
autonomously developing a mission plan for the fleet of unmanned vehicles based on mission objectives;
coordinating with autonomous engines to generate an action plan for autonomous execution of the mission plan by a set of the unmanned vehicles;
communicating mission instructions to on-board systems of the set of the unmanned vehicles via the off-board transport interface based on the action plans; and
receiving mission data from at least one of the set of the unmanned vehicles via the off-board transport interface during the autonomous execution of the mission plan.

18. The system of claim 17, wherein the steps further comprise:
performing real-time, off-board processing of mission data during the autonomous execution of the mission plan.

19. The system of claim 18, wherein the steps further comprise:
generating, from the processed mission data, during the autonomous execution of the mission plan, one or more of a handover trigger, a mission depart trigger, or a tasking/configuration trigger event.

20. The system of claim 17, wherein:
at least a first unmanned vehicle of the set of the unmanned vehicles is in communication via a first of the multiple transport networks, and at least a second unmanned vehicle of the set of the unmanned vehicles is in communication via a second of the multiple transport networks;
the communicating comprises communicating the mission instructions to the first unmanned vehicle over the first of the multiple transport networks and communicating the mission instructions to the second unmanned vehicle over the second of the multiple transport networks; and
the receiving comprises receiving the mission data from the first unmanned vehicle over the first of the multiple transport networks and receiving the mission data from the second unmanned vehicle over the second of the multiple transport networks.
